(19) United States
(12) Patent Application Publication
(10) Pub. No.: US 2011/0052295 A1
(43) Pub. Date: Mar. 3, 2011

(54) LABEL PRINTING DEVICE AND LABEL PRINTING METHOD

(75) Inventor: Okiharu Matsuda, Shizuoka (JP)

(73) Assignee: TOSHIBA TEC KABUSHIKI KAISHA, Tokyo (JP)

(21) Appl. No.: 12/868,980

(22) Filed: Aug. 26, 2010

(30) Foreign Application Priority Data
Sep. 1, 2009 (JP) 2009-201875

(51) Int. Cl. B41J 11/44

(52) U.S. Cl. 400/76

(57) ABSTRACT

According to one embodiment, a label printing device connected to an external device includes a reading unit, a printing unit, and a controller. The reading unit is configured to read management data. The printing unit is configured to print a label image on a recording medium based on printing data corresponding to the management data. The controller is configured to determine whether the printing data corresponding to the management data exists in a storage region. If the printing data exists in the storage region, the controller is further configured to control the printing unit to print the label image on the recording medium using the printing data.

### CROSS-REFERENCE TO RELATED APPLICATIONS

This application is based upon and claims the benefit of priority from Japanese Patent Application No. 2009-201875, filed on Sep. 1, 2009, the entire contents of which is incorporated herein by reference.

### FIELD

Embodiments described herein relate generally to a label printing device which may print a label image on a recording medium such as a label by using a reading unit that reads control information, and to a label printing device and a label printing method which may reuse once-used printing data for a printing operation.

### BACKGROUND

Recently, label printing devices have been manufactured and used which may issue a pop label without inputting information with keys regarding a product name, a price, or the like one by one. The label printing device may print and issue the pop label to identify a product name, a manufacturer name, a bargain price, or the like. Thus, the label printing device is used in a retail shop or the like to facilitate the sales of the products.

In general, the label printing device for issuing the pop label is often used through the connection to a POS system to which a plurality of POS terminals are connected, e.g., via a LAN (Local Area Network) or the like.

### BRIEF DESCRIPTION OF THE DRAWINGS

FIG. 1 is a block diagram showing an example of a label printing device.

FIG. 2 is a schematic diagram of an example of a label printing device.

FIG. 3 is a flowchart showing an example of a history information management process of the label printing device.

FIG. 4 is a flowchart showing an example of a history information management process of the label printing device.

FIG. 5 is a flowchart showing an example of a history information management process of the label printing device.

### DETAILED DESCRIPTION

In general, according to one embodiment, a label printing device connected to an external device may include a reading unit, a printing unit, and a controller. The reading unit is configured to read management data. The printing unit is configured to print a label image on a recording medium based on printing data corresponding to the management data. The controller is configured to determine whether the printing data corresponding to the management data exists in a storage region. If the printing data exists in the storage region, the controller is further configured to control the printing unit to print the label image on the recording medium using the printing data.

Embodiments will now be described in detail with reference to the drawings.

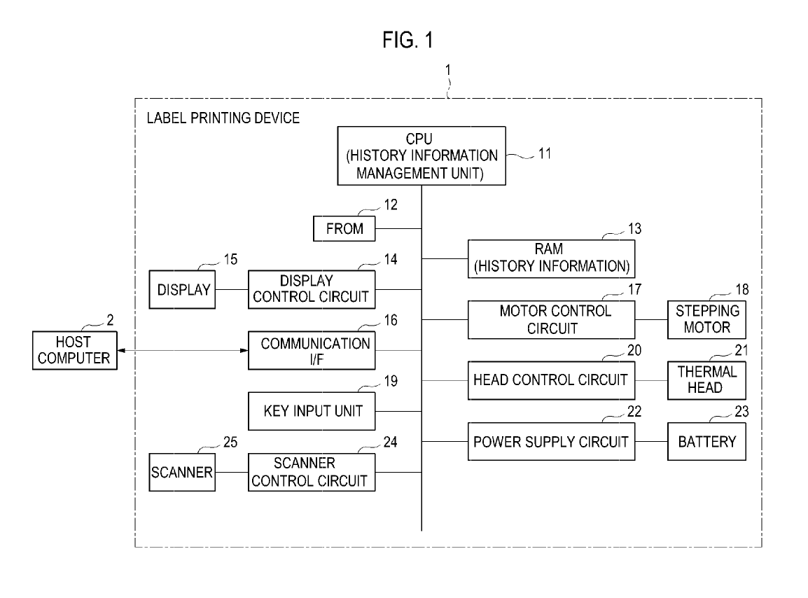

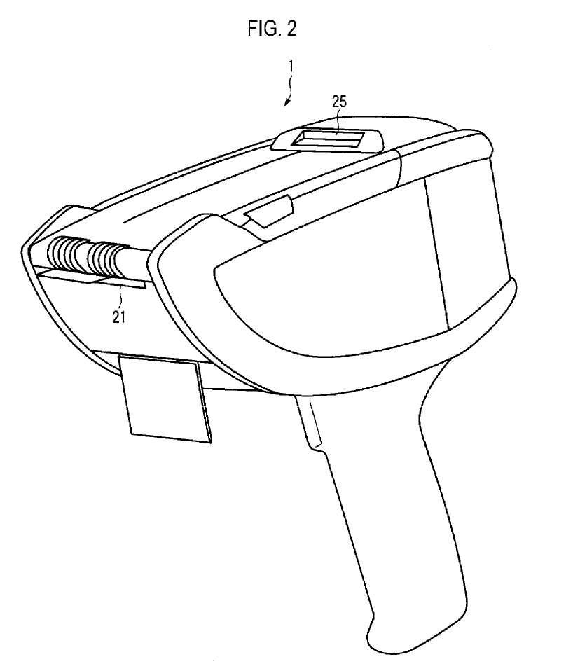

FIG. 1 is a block diagram showing an example of a label printing device according to one embodiment, and FIG. 2 is a schematic diagram showing an overview of an example of the label printing device according to one embodiment.

In one embodiment, as shown in FIG. 1, a label printing device 1 may be connected to an external device (e.g., a host computer 2) via a network or the like. The label printing device 1 may include a CPU 11 as a controller that is configured to control the overall operation, and functions to be a history information management unit. The label printing device 1 may further include a FROM 12 and a RAM 13 that are connected to the CPU 11. The RAM 13 (as a storage region) stores previously-used history information, management data indicated by a barcode or the like and printing data corresponding to the management data. For example, the printing data stored in RAM 13 may include image data such as bit map image data.

The label printing device 1 may include a display control circuit 14, a display 15 which is configured to display operation information or label information under control of the display control circuit 14, and a communication interface 16 as an example of a communication unit for communicating with the host computer 2 to acquire printing data corresponding to management data. The label printing device 1 may further include a motor control circuit 17, a stepping motor 18 whose operation is controlled by the motor control circuit 17, a key input unit 19 with which a user may input operation information or the like, a head control circuit 20 for printing a label (on which a price is printed and which is to be attached to a product in a shop) on a medium, a thermal head 21 as a printing unit whose operation is controlled by the head control circuit 20 and which performs a printing operation on the medium of the label, a power supply circuit 22 which supplies power to each part/unit, a battery 23 which supplies power to the power supply circuit 22, a scanner control circuit 24, and a scanner 25 as a reading unit, controlled by the scanner control circuit 24, for reading the bar code. The above-described elements may be respectively connected to the CPU 11.

FIG. 2 shows an overview of the label printing device 1 according to one embodiment. The scanner 25 is mounted on the label printing device 1, as the reading unit which may read management data of the label. The thermal head 21 may perform a label printing operation.

The label printing device 1 having the above-described configuration may start a printing process from an operation of reading management data of a bar code or a two-dimensional code. The label printing device 1 transmits the management data to the host computer 2 in a wired or wireless manner. Based on the management data, the host computer 2 may generate information (a printing format) necessary for printing and transmit the generated information to the label printing device 1 in the wired or wireless manner. The label printing device 1 may generate printing data corresponding to the received printing format to thereby print a label. When the label printing is completed, the printed label is attached to a corresponding product by the user.

In one embodiment, the label printing device may store as history information previously-used management data (a bar code or the like) and a printing format corresponding to the management data (corresponding printing data) in the RAM 13. When management data indicated by the bar code that is scanned by the scanner 25 exists within the history information, the label printing device 1 may rapidly print a label using the printing format (corresponding printing data) in the history information without making an inquiry to the external host computer 2. That is, in one embodiment, the operations at the side of the host computer 2 of receiving bar code data, generating printing data from the received bar code data, and transmitting the generated printing data to a printer may be omitted.

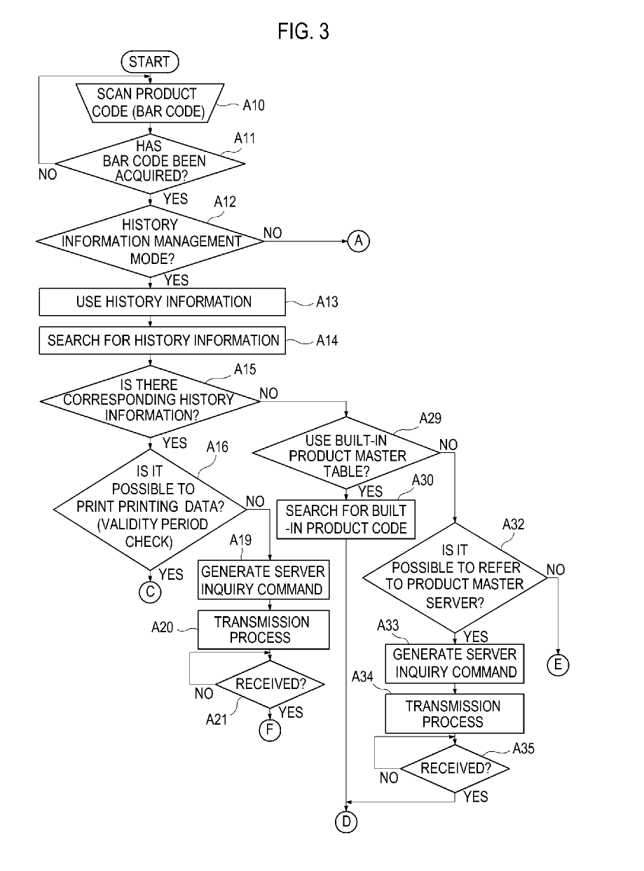

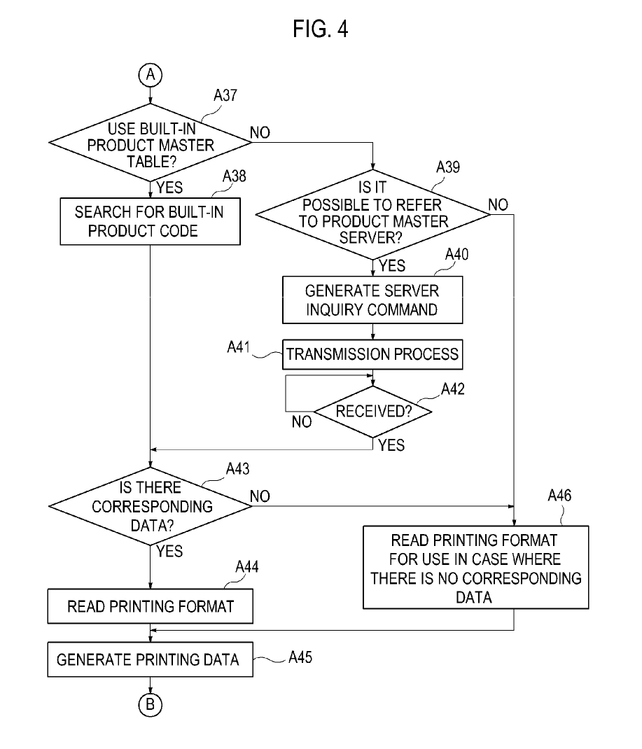

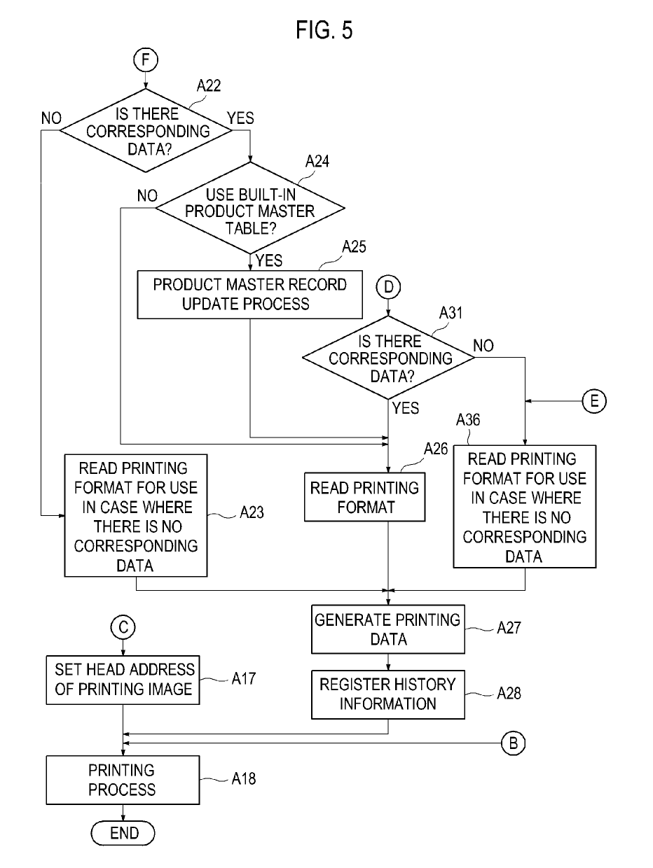

Hereinafter, a printing process associated with the history information management process in the label printing device 1 having the above-described configuration will be described in detail with reference to the flowcharts. FIGS. 3 to 5 show flowcharts illustrating the printing process associated with the history information management process of the label printing device in one embodiment.

In the label printing device 1, the key input unit 19 may include a trigger button for scanning by the scanner 25. Upon pushing the trigger button, the CPU 11 may operate the scanner control circuit 24 and the scanner 25 to read a bar code or a two-dimensional code (act A10). When the CPU 11 acquires the management data such as the bar code (act A11), the CPU 11 may determine whether or not a history information management mode is selected at the present time (act A12). If the CPU 11 determines that the history information management mode is selected at the present time, the CPU 11 may determine to use the history information (act A13), and the CPU 11 may search for the history information from the RAM 13 (act A14).

Based on the search results, when the CPU 11 determines that history information is available within the RAM 13 (act A15), the CPU 11 may check a validity period of printing data included in the history information so as to determine whether the printing data can be used for printing (act A16). If the CPU 11 determines that the printing data is in the validity period and thus the printing data can be used for printing, the CPU 11 may set a head address of the printing data in the RAM 13 (act A17). Based on the printing data for which the head address is set, the CPU 11 may print an image on a label as a recording medium by using the head control circuit 20 and the thermal head 21 (act A18).

In act A12, when the CPU 11 determines that the history information management mode is not selected, the CPU 11 may determine whether to use a built-in product master table stored in the RAM 13 (act A37). When the CPU 11 determines to use the built-in product master table stored in the RAM 13, the CPU 11 may search for a product code corresponding to management data of a bar code (act A38). When the CPU 11 determines that there is the data (e.g., product code) corresponding to the management data (YES of act A43), the CPU 11 may be operable to read a printing format of the product code (act A44) and generate printing data (act A45). Based on the printing data which CPU 11 generates, the CPU 11 may print a label image on a label by using the head control circuit 20 and the thermal head 21 (act A18).

In act A37, when the CPU 11 determines not to use the built-in product master table stored in the RAM 13, the CPU 11 may determine whether it is possible to refer to a product master server (e.g., the host computer 2) via a network (act A39). When the CPU 11 determines that it cannot refer to the product master server via the network (NO of act A39), the CPU 11 may be operable to read a printing format in the case of “No corresponding data” from the RAM 13 (act A46), and generate printing data to print a label image using the head control circuit 20 and the thermal head 21 (acts A45 and A18).

In act A39, when the CPU 11 determines that it is possible to refer to the product master server via the network, the CPU 11 may generate a server inquiry command (act A40), and transmit the generated server inquiry command to the product master server on the network through the communication interface 16 (act A41). As a result, when the CPU 11 receives a corresponding product code from the product master server through the communication interface 16 (YES of act A42), the CPU 11 proceeds to act A43. When there is data corresponding to the product code (YES of act A43), the CPU 11 may be operable to read a printing format of the product code (act A44) and generate printing data (act A45). Thereafter, the CPU 11 may perform the printing process based on the printing data (act A18).

In act A43, when the CPU 11 determines that there is no corresponding data (NO of act A43), the CPU 11 proceeds to act A46 and may read a printing format for use in the case where there is no corresponding data.

In act A15, when the CPU 11 determines that there is no corresponding history information in the RAM 13, the CPU 11 may determine whether to use the built-in product master table stored in the RAM 13 (act A29). When the CPU 11 determines to use the built-in product master table stored in the RAM 13 (YES of act A29), the CPU 11 may search for a product code corresponding to management data of a bar code (act A30). When there is data corresponding to the product code (YES of act A31), the CPU 11 may read a printing format of the product code (act A26) and generate printing data (act A27). Thereafter, the CPU 11 may register the history information to the RAM 13 (act A27) and then perform the printing process using the head control circuit 20 and the thermal head 21 (act A18).

In act A29, when the CPU 11 determines not to use the built-in product master table stored in the RAM 13 (NO of act A29), the CPU 11 may determine whether it is possible to refer to the product master server via the network (act A32). When the CPU 11 determines that it cannot refer to the product master server via the network, the CPU 11 may read a printing format for use in the case of “No corresponding data” from the RAM 13 (act A36), generate printing data (act A27), register history information (act A28), and perform the printing process using the head control circuit 20 and the thermal head 21 (act A18).

In act A32, when the CPU 11 determines that it is possible to refer to the product master server via the network, the CPU 11 may generate a server inquiry command (act A33), and transmit the generated server inquiry command to the product master server through the communication interface 16 (act A34). As a result, when the CPU 11 receives a corresponding product code from the product master server through the communication interface 16 (YES of act A35), the CPU 11 proceeds to act A31. When there is data corresponding to the product code (YES of act A31), the CPU 11 may read a printing format of the product code (act A26) and generate printing data (act A27). Thereafter, the CPU 11 may register history information (act A28) and perform the printing process based on the printing data (act A18).

In act A16, when the CPU 11 determines the validity period expired and the printing data should not be used to print (NO of act A16), the CPU 11 may generate an inquiry command directed to the host computer 2 (act A19) and transmit the generated inquiry command to the host computer 2 on the network through the communication interface 16 (act A20). As a result, when the label printing device 1 receives corresponding printing data from the host computer 2 through the communication interface 16 (act A21), the CPU 11 proceeds to act A22. When there is data corresponding to the product code (YES of act A22), the CPU 11 may determine whether to use the built-in product master table of the printing data (act A24). In the case of using the built-in product master table, the CPU 11 may update a product master record (act A25) and thereafter proceeds to act A26. In the case of not using the built-in product master table, the CPU 11 directly proceeds to act A26 and thereafter may read a print format, generate printing data, register history information, and perform a printing process (acts A26, A27, A28, and A18).

In act A22, when the CPU 11 determines that a corresponding printing data cannot be acquired from the host computer 2 (NO of act A22), the CPU 11 may read a printing format for use in the case of “No corresponding data” from the RAM 13 (act A23), generate a printing data (act A27), register history information (act A28), and perform the printing process using the head control circuit 20 and the thermal head 21 (act A18).

Here, as a process in the case where a corresponding printing data from the host computer 2 does not exist, it is possible to notify the user of an error message by simply displaying the error message on a screen in the display 15 using an LCD (Liquid Crystal Display), an LED (Light Emitting Diode), or the like in addition to a method of printing a printing format indicating “No corresponding image” In this case, it may become unnecessary to print the printing format and thus label consumption can be prevented.

As described above with reference to the flowchart of FIGS. 3 to 5, the label printing device 1 in one embodiment may perform scanning and printing collectively by a trigger button of the scanner, and particularly, store previous history information in the RAM 13. When management data indicated by a scanned bar code exists in the history information, the label printing device 1 may use a printing format (or printing data) corresponding to the management data, thereby making it possible to rapidly print a label by omitting the operations to be performed on the host computer 2 of receiving bar code data, generating printing data from the received bar code data, and transmitting the generated printing data to a printer.

In one embodiment, a specific operation example of operating the label printing device 1 includes the “issuance of a markdown label.” For example, a markdown label to be used on clothing is generally attached later to a price tag label of a product. A bar code may be different when the size of clothing having the same product code is different. In this case, there is almost no possibility that the same bar code may be continuously scanned. When an inquiry to the host computer 2 is made on a case-by-case basis through wireless communication, a delay may occur due to external factors in the communication environment and thus it may take time to print, so that the psychological burden of a worker may be increased. According to the label printing device 1 in one embodiment, it is possible to rapidly execute a printing process to print an image of a markdown label corresponding to one price tag label using built-in history information.

A plurality of ranges of predetermined validity periods in which history information (management data and printing data) is referred to may be selected. That is, the restriction/management at the side of the host computer 2 may be reflected by setting the number of history items or setting a validity period-limited printing.

As the above-described predetermined period, in some embodiments history information is set for the day by the action of the CPU 11 and the program built in the RAM 13 or the FROM 12, and to automatically delete history information of yesterday or before by the operation of the CPU 11. In some embodiments, history information is used for one week and automatically deleted after one week passes. Thereby, it is possible to prevent old price information or label information from being mixed with current price information or label information without being updated.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses. In one embodiment, the validity period may not be limited to a time period or duration but may be defined by specifying a certain date within which history information is valid. For example, the validity period may be specified by “Jun. 1, 2010,” on which history information is valid.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) or the like in the apparatus.

While certain embodiments have been described, these embodiments have been presented by way of example only, and are not intended to limit the scope of the inventions. Indeed, the novel device and method described herein may be embodied in a variety of other forms; furthermore, various omissions, substitutions and changes in the form of the device and method described herein may be made without departing from the spirit of the inventions. The accompanying claims and their equivalents are intended to cover such forms or modifications as would fall within the scope and spirit of the inventions.

What is claimed is:

1. A label printing device connected to an external device, the label printing device comprising:
a reading unit configured to read management data;
a printing unit configured to print a label image on a recording medium based on printing data corresponding to the management data; and
a controller configured to determine whether the printing data that corresponds to the management data exists in a storage region of the label printing device, and if the printing data exists in the storage region, the controller is further configured to control the printing unit to print the label image on the recording medium using the printing data.

2. The label printing device of claim 1, wherein when a predetermined operation mode is selected, the controller is configured to determine whether the printing data exists in the storage region of the label printing device, and if the printing data exists in the storage region, the controller is configured to control the printing unit to print the label image on the recording medium using the printing data.

3. The label printing device of claim 1, wherein after the printing unit prints the label image, the controller is configured to store the printing data used for printing in the storage region in association with the management data.

4. The label printing device of claim 1, wherein after the printing unit prints the label image, the controller is configured to store the printing data used for printing in the storage region in association with the management data, and the controller is further configured to delete the printing data and the management data from the storage region when a predetermined period has elapsed.

5. The label printing device of claim 2, wherein if the printing data exists in the storage region, the controller is further configured to check a validity period of the printing data, and if the controller determines that the printing data is in the validity period, the controller is further configured to control the printing unit to print the label image.

6. The label printing device of claim 1, further comprising a communication unit configured to communicate with the external device.

7. The label printing device of claim 1, further comprising a key input unit with which a user may input operation information.

8. The label printing device of claim 7, wherein the key input unit includes a trigger button configured to operate the reading unit to read the management data.

9. The label printing device of claim 1, wherein when a predetermined operation mode is not selected, the controller is configured to determine whether to use a built-in product master table stored in the storage region; and if the controller determines to use a built-in product master table, the controller is further configured to generate the printing data based on a printing format of a product code in the built-in product master table.

10. The label printing device of claim 9, wherein if the controller determines not to use the built-in product master table, the controller is further configured to refer to a product master server via a network.

11. A label printing method using a label printing device connected to an external device and having a reading unit configured to read management data, the label printing method comprising;
reading management data by using the reading unit;
determining whether the management data corresponds to printing data stored in a storage region of the label printing device; and
printing a label image on a recording medium using the printing data if the printing data exists in the storage region.

12. The label printing method of claim 11, wherein when a predetermined operation mode is selected, a controller of the label printing device is operable to determine whether the printing data corresponding to the management data read by the reading unit exists in the storage region, and if the printing data exists in the storage region, the controller is further operable to print the label image on the recording medium by using the printing data.

13. The label printing method of claim 11, further comprising after printing the label image, storing the printing data used for printing in the storage region in association with the management data.

14. The label printing method of claim 13, further comprising deleting the printing data and the management data from the storage region when a predetermined period has elapsed.

15. The label printing method of claim 12, wherein if the printing data exists in the storage region, the controller is further operable to check a validity period of the printing data, and if the controller determines that the printing data is in the validity period, the controller is further operable to control the printing unit to print the label image.

16. The label printing method of claim 11, wherein when a predetermined operation mode is not selected, the controller is operable to determine whether to use a built-in product master table stored in the storage region; and if the controller determines to use a built-in product master table, the controller is further configured to generate the printing data based on a printing format of a product code in the built-in product master table.

17. The label printing method of claim 16, wherein if the controller determines not to use the built-in product master table, the controller is further operable to refer to a product master server via a network.

18. A computer-readable storage medium storing instructions that, when executed by a computer, cause the computer to perform a label printing method comprising:
reading management data through a reading unit of a label printing device;
determining whether the management data corresponds to printing data stored in a storage region of a label printing device; and
printing a label image on a recording medium using the printing data if the printing data exists in the storage region.

19. The computer-readable storage medium of claim 18 further comprising:
determining whether the printing data exists in the storage region of the label printing device when a predetermined operation mode is selected; and
printing the label image on the recording medium using the printing data if the printing data exists in the storage region.

20. The computer-readable storage medium of claim 18 further comprising storing the printing data used for printing in the storage region in association with the management data after the printing unit prints the label.
